(19) United States
(12) Patent Application Publication
(10) Pub. No.: US 2005/0160403 A1
(43) Pub. Date: Jul. 21, 2005

(54) Method for accessing an ERP from a mobile equipment unit

(75) Inventor: Christophe Nivelet, Boulogne-Billancourt (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Bouygues Telecom, a corporation of France, Boulogne-Billancourt (FR)

(21) Appl. No.: 10/974,212

(22) Filed: Oct. 27, 2004

(30) Foreign Application Priority Data
Nov. 4, 2003 (FR) 03/50783

(51) Int. Cl. G06F 9/44

(52) U.S. Cl. 717/116; 709/231; 709/203

(57) ABSTRACT

A method for accessing an ERP (Enterprise Resource Planning) from a mobile equipment unit including downloading a Java™ application on the mobile equipment unit; and transmitting at least one request to the ERP from the mobile equipment unit, wherein the request is generated by the Java application and proceeds via the following pathway: advancing in an XML format via a mobile telecommunications network to a TM-IS gateway [Telecommunications-Information System]; and transmitting the request from the TM-IS gateway to the ERP via a Web services interface; and a system that implements the method according to claim 1, comprising: at least one mobile equipment unit, a TM-IS gateway [Telecommunications-Information System], an ERP and a Web services interface.

### RELATED APPLICATION

This application claims priority of French Patent Application No. 03/50783, filed Nov. 4, 2003.

### FIELD OF THE INVENTION

This invention pertains to the field of information and communication technologies. The invention pertains more specifically to a method for accessing an ERP (Enterprise Resource Planning) module of an information system from a mobile equipment unit. The invention also pertains to a system to implement the method.

ERP modules have been employed in numerous large enterprises since the 1990s. They are employed, e.g., for managing inventory or bookkeeping. Companies such as SAP, Oracle and PeopleSoft market such software packages. Such an application has now become an essential technological component of the information system of a large enterprise.

One of the major technological challenges at present in the field of ERP management software packages is remote access. An example of use is remote access by a commercial representative to ascertain the inventory status of a given product.

In the process of standardization of Java™ and Sun (JCP or Java Community Process), a new JSR (Java Specification Request) was presented: JSR-172 which indicates how to implement from a J2METM Java™-compatible terminal exchanges with a network gateway using an XML format.

Already known are solutions enabling access to an ERP from a PDA (Personal Digital Assistant). Such a PDA application has a size of several tens of mega-octets, which is incompatible with a mobile telecommunication terminal that has limited data and software resources.

U.S. 2001/0051890 discloses a method for remote access to an SAP database. This method assumes the existence of a server (productivity center) generating XML requests to the management system and it receives the data from this server. A client can then interface with the server in order to have access to the SAP data.

WO 00/56033 discloses that a light client accesses data on a remote Web server via the Wap. A gateway then translates the requests from the light user into XML requests for the Web server.

Lastly, WO 02/15604 discloses a data communication system used to link a remote application and a mobile equipment unit. XML requests are then generated by the system for access to the application.

In a general manner, the above-mentioned prior art does not allow local processing of the requests at level of the mobile equipment unit. It would therefore be advantageous to provide an end-to-end application for access to a remote ERP.

### SUMMARY OF THE INVENTION

This invention relates to a method for accessing an ERP (Enterprise Resource Planning) from a mobile equipment unit including downloading a Java™ application on the mobile equipment unit; and transmitting at least one request to the ERP from the mobile equipment unit, wherein the request is generated by the Java application and proceeds via the following pathway: advancing in an XML format via a mobile telecommunications network to a TM-IS gateway [Telecommunications-Information System]; and transmitting the request from the TM-IS gateway to the ERP via a Web services interface.

This invention also relates to a system that implements the method including at least one mobile equipment unit, a TM-IS gateway [Telecommunications-Information System], an ERP and a Web services interface.

### BRIEF DESCRIPTION OF THE DRAWING

Better understanding of the invention will be obtained from the description presented below purely for explanatory purposes of one mode of implementation of the invention with reference to the attached figure:

FIG. 1 illustrates a system implementing aspects of the method according to the invention.

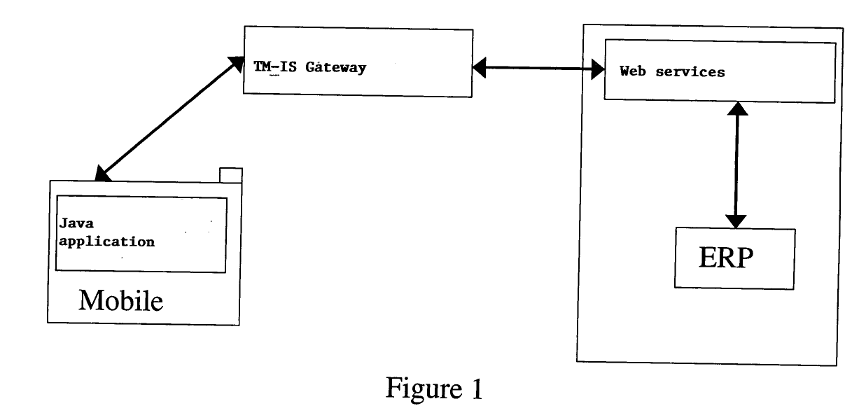

### DETAILED DESCRIPTION

This invention pertains in its most general sense to a method for accessing an ERP (Enterprise Resource Planning) from a mobile equipment unit comprising the following steps:
downloading a Java™ application on the mobile equipment unit;
transmitting at least one request to the ERP from the mobile equipment unit;
the request being generated by the Java application and proceeding via the following pathway:
advancing in an XML format via a mobile telecommunications network to a TM-IS gateway [Telecommunications-Information System];
transmission of the request from the TM-IS gateway to the ERP via a Web services interface.

The method preferably also comprises a step of processing by the ERP of the request and sending back a response from the ERP to the mobile equipment unit via a Web services interface. The mobile equipment unit is preferably a Java-compatible mobile telecommunications terminal.

According to one aspect, the TM-IS gateway is a Wap gateway. The Web services interface is preferably integrated with the ERP, but need not be so integrated with the ERP.

The invention also pertains to a system to implement the method comprising at least one mobile equipment unit, a TM-IS gateway [Telecommunications-Information System], an ERP and a Web services interface.

We shall now describe one preferred system employing aspects of the method according to the invention.

We start with the following:
1. A GSM-compatible GPRS mobile telecommunications network comprising a Wap gateway;
2. An IS (enterprise information system) comprising at least one ERP component and a Web services component.

Access to the ERP by the user of a Java™-compatible mobile terminal may be implemented in the following manner:
A) A specific application written and compiled in Java programming language is downloaded on the mobile terminal.
B) The user sends a request by the application to the ERP.
C) The request is translated into a XML-based format (e.g., SOAP) and then transmitted to the Wap gateway via the mobile telecommunications network. It is possible, as an example, to use the functionalities defined by the specification JSR 172 for the translation and the transmission of the request.
D) The request is then transmitted to the Web services interface of the enterprise IS via a connection.
E) The request is lastly transmitted from the enterprise IS to the ERP.
F) The request is processed by the ERP and a response is transmitted to the mobile equipment unit via the same pathway.

The invention was described above as an example. It is understood that one skilled in the art can implement different aspects of the invention without thereby departing from the scope of the invention as defined in the appended claims.

1. A method for accessing an ERP (Enterprise Resource Planning) from a mobile equipment unit comprising:
downloading a Java™ application on the mobile equipment unit; and
transmitting at least one request to the ERP from the mobile equipment unit, wherein the request is generated by the Java application and proceeds via a pathway:
advancing in an XML format via a mobile telecommunications network to a TM-IS gateway [Telecommunications-Information System]; and
transmitting the request from the TM-IS gateway to the ERP via a Web services interface.

2. The method according to claim 1, further comprising processing the request by the ERP and sending back a response from the ERP to the mobile equipment unit via a Web services interface.

3. The method according to claim 1, wherein the mobile equipment unit is a Java-compatible mobile telecommunications terminal.

4. The method according to claim 1, wherein the TM-IS gateway is a Wap gateway.

5. The method according to claim 1, wherein the Web services interface is integrated with the ERP.

6. The method according to claim 1, wherein the Web services interface is not integrated with the ERP.

7. A system that implements the method according to claim 1, comprising: at least one mobile equipment unit, a TM-IS gateway [Telecommunications-Information System], an ERP and a Web services interface.
